(19) United States
(12) Patent Application Publication
(10) Pub. No.: US 2023/0393883 A1
(43) Pub. Date: Dec. 7, 2023

(54) OBSERVABILITY AND AUDIT OF AUTOMATIC REMEDIATION OF WORKLOADS IN CONTAINER ORCHESTRATED CLUSTERS

(71) Applicant: VMware, Inc., Palo Alto, CA (US)

(72) Inventors: Lachezar TSONOV, Sofia (BG); Raz OMESSI, New York, NY (US); Michael BERDICHEVSKY, Tel Aviv (IL)

(21) Appl. No.: 18/326,546

(22) Filed: May 31, 2023

Related U.S. Application Data
(60) Provisional application No. 63/347,777, filed on Jun. 1, 2022.

(51) Int. Cl. G06F 9/455

(52) U.S. Cl. CPC G06F 9/45558; G06F 2009/4557

(57) ABSTRACT

An example method of handling a user request to modify state of a container workload in a data center includes: receiving the user request at a container orchestrator executing in the data center, the container orchestrator managing the container workload, the container workload executing on a host in the data center; notifying, by the container orchestrator, a management agent of the user request, the management agent executing in the data center; receiving, at the container orchestrator from the management agent, an annotated user request and a remediation patch, the annotated user request including metadata describing policies and patches defined in the remediation patch; applying, by the container orchestrator, the remediation patch to the annotated user request to generate a remediated user request; and persisting, by the container orchestrator, a state of the container workload in response to the remediated user request.

### CROSS-REFERENCE TO RELATED APPLICATIONS

This application claims priority to U.S. Provisional Patent Application Ser. No. 63/347,777, filed Jun. 1, 2022, which is incorporated by reference herein in its entirety.

### BACKGROUND

Applications today are deployed onto a combination of virtual machines (VMs), containers, application services, physical servers without virtualization, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A user, or automated software on behalf of an Infrastructure as a Service (IaaS), interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

For deploying applications in an SDDC, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling. In a Kubernetes system, containers are grouped into logical unit called “pods” that execute on nodes in a cluster (also referred to as “node cluster”). Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod.

Kubernetes is a complex platform with many configuration options and implementation details that can be misconfigured by users. Further, cluster operators and cluster users can be in entirely different groups or departments. This leads to a slow feedback loop between cluster operators and cluster users when finding a violation by cluster operators, communicating the violation to cluster users, and cluster operators waiting for a fix by cluster users (“remediation”).

### SUMMARY

In an embodiment, a method of handling a user request to modify state of a container workload in a data center includes: receiving the user request at a container orchestrator executing in the data center, the container orchestrator managing the container workload, the container workload executing on a host in the data center; notifying, by the container orchestrator, a management agent of the user request, the management agent executing in the data center; receiving, at the container orchestrator from the management agent, an annotated user request and a remediation patch, the annotated user request including metadata describing policies and patches defined in the remediation patch; applying, by the container orchestrator, the remediation patch to the annotated user request to generate a remediated user request; and persisting, by the container orchestrator, a state of the container workload in response to the remediated user request.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a cloud control plane implemented in a public cloud and an SDDC that is managed through the cloud control plane, according to embodiments.

FIG. 2 is a block diagram of an SDDC in which embodiments described herein may be implemented.

FIG. 3 is a block diagram depicting components of a container orchestrator, a management agent, and a management service according to embodiments.

FIG. 4 is a flow diagram depicting a method of remediating a user request to modify, state of a container workload according to embodiments.

FIG. 5 is a flow diagram depicting a method of processing the remediated workload state by management service 120 according to an embodiment.

### DETAILED DESCRIPTION

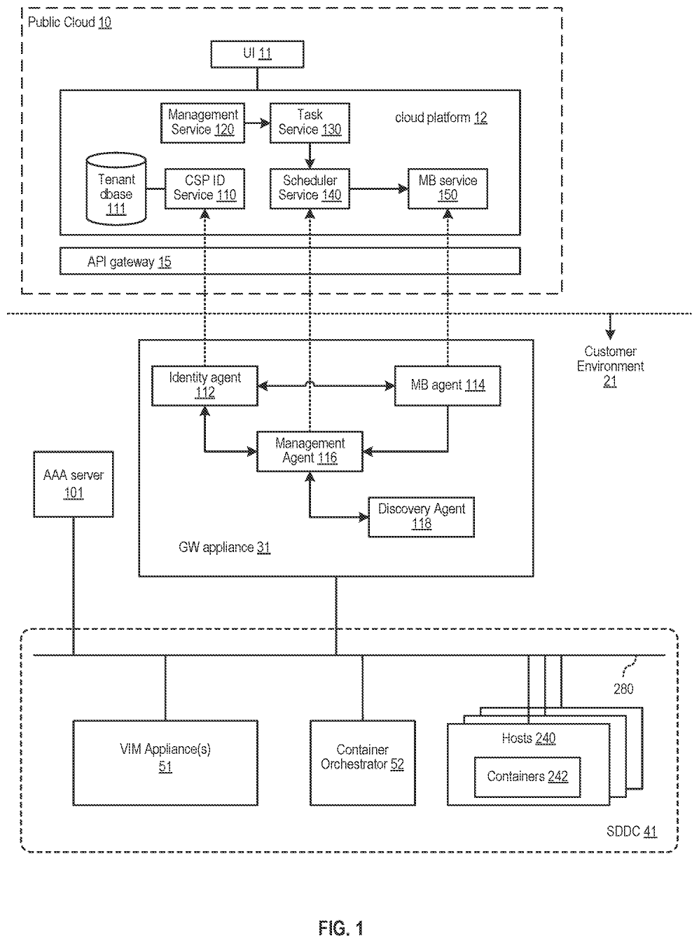

FIG. 1 is a block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 1 as UI 11.

An SDDC is depicted in FIG. 1 in a customer environment 21. In the customer environment, the SDDC is managed by respective virtual infrastructure management (VIM) appliances, e.g., VMware vCenter® server appliance and VMware NSX® server appliance. The VIM appliances in each customer environment communicate with a gateway (GW) appliance, which hosts agents that communicate with cloud platform 12, e.g., via a public network, to deliver cloud services to the corresponding customer environment. For example, the VIM appliances for managing the SDDCs in customer environment 21 communicate with GW appliance 31.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions. While embodiments are described herein with respect to SDDCs, it is to be understood that the techniques described herein can be utilized in other types of data center management approaches.

In the embodiments, the gateway appliance and the management appliances are a VMs instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the gateway appliance and the management appliances may be implemented as physical host computers having the conventional hardware platform described above.

FIG. 1 illustrates components of cloud platform 12 and GW appliance 31. The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs and the URL of the tenant's AAA (authentication, authorization and accounting) server 101, is collected, and user IDs and passwords for accessing (i.e., logging into) cloud platform 12 through UI 11 are set up for the tenant. The user IDs and passwords are associated with various users of the tenant's organization who are assigned different roles. The tenant profile information is stored in tenant dbase 111, and login credentials for the tenants are managed according to conventional techniques, e.g., Active Directory® or LDAP (Lightweight Directory Access Protocol).

In one embodiment, each of the cloud services is a microservice that is implemented as one or more container images executed on a virtual infrastructure of public cloud 10. The cloud services include a cloud service provider (CSP) ID service 110, a management service 120, a task service 130, a scheduler service 140, and a message broker (MB) service 150. Similarly, each of the agents deployed in the GW appliances is a microservice that is implemented as one or more container images executing in the gateway appliances.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to a request from identity agent 112 if the request contains valid credentials.

In the embodiment, management service 120 is configured to provide a solution to ensure compliance and security management in container orchestrated clusters (e.g., Kubernetes clusters). Management service 120 cooperates with a management agent 116 in GW appliance 31 of customer environment 21. Management agent 116 is configured to identify misconfiguration and workload risks in container orchestrated clusters in SDDC 41. SDDC 41 includes a container orchestrator 52 (e.g., a Kubernetes master server) that manages containers 242 executing in hosts 240.

Management service 120 and management agent 116 can communicate directly or through a messaging system. For the messaging system, at predetermined time intervals, MB agent 114, which is deployed in GW appliance 31, makes an API call to MB service 150 to exchange messages that are queued in their respective queues (not shown), i.e., to transmit to MB service 150 messages MB agent 114 has in its queue and to receive from MB service 150 messages MB service 150 has in its queue. In the embodiment, messages from MB service 150 are routed to management agent 116 if the messages are from management service 120.

Discovery agent 118 communicates with the management appliances of SDDC 41 to obtain authentication tokens for accessing the management appliances. In the embodiments, entitlement agent 116 acquires the authentication token for accessing the management appliance from discovery agent 118 prior to issuing commands to the management appliance and includes the authentication token in any commands issued to the management appliance.

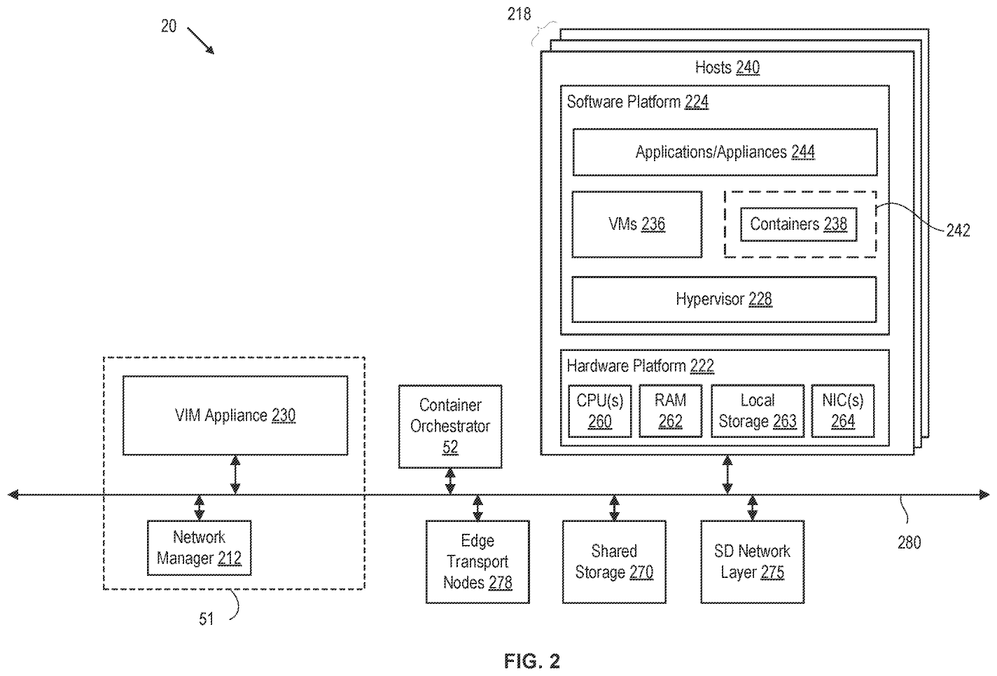

FIG. 2 is a block diagram of SDDC 41 in which embodiments described herein may be implemented. SDDC 41 includes a cluster of hosts 240 (“host cluster 218”) that may be constructed on server-grade hardware platforms such as an x86 architecture platforms. For purposes of clarity, only one host cluster 218 is shown. However, SDDC 41 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (EC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN (vSAN), which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed. Applications and/or appliances 244 execute in VMs 236 and/or containers 238 (discussed below).

Host cluster 218 is configured with a software-defined (SD) network layer 275. SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, SDDC 41 includes edge transport nodes 278 that provide an interface of host cluster 218 to a wide area network (WAN) (e.g., a corporate network, the public Internet, etc.).

VIM appliance 230 is a physical or virtual server that manages host cluster 218 and the virtualization layer therein. VIM appliance 230 installs agent(s) in hypervisor 228 to add a host 240 as a managed entity. VIM appliance 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. VIM management appliance 51A can manage more than one host cluster 218.

In an embodiment, SDDC 41 further includes a network manager 212. Network manager 212 (another management appliance) is a physical or virtual server that orchestrates SD network layer 275. In an embodiment, network manager 212 comprises one or more virtual servers deployed as VMs. Network manager 212 installs additional agents in hypervisor 228 to add a host 240 as a managed entity, referred to as a transport node. In this manner, host cluster 218 can be a cluster of transport nodes. One example of an SI) networking platform that can be configured and used in embodiments described herein as network manager 212 and SD network layer 275 is a VMware NSX® platform made commercially available by VMware, Inc. of Palo Alto, CA.

In embodiments, SDDC 401can include a container orchestrator 52. Container orchestrator 52 implements an orchestration control plane, such as Kubernetes, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 52 can include one or more master servers configured to command and configure pod VM controllers in host cluster 218. Master server(s) can be physical computers attached to network 280 or VMs 236 in host cluster 218. Container orchestrator 52 can also manage containers deployed in VMs 236 (e.g., native VMs).

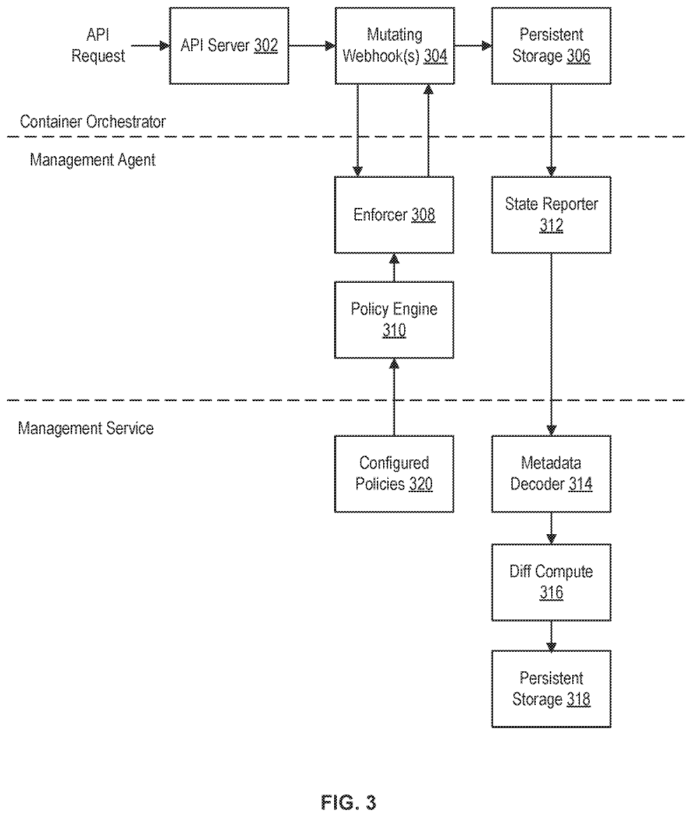

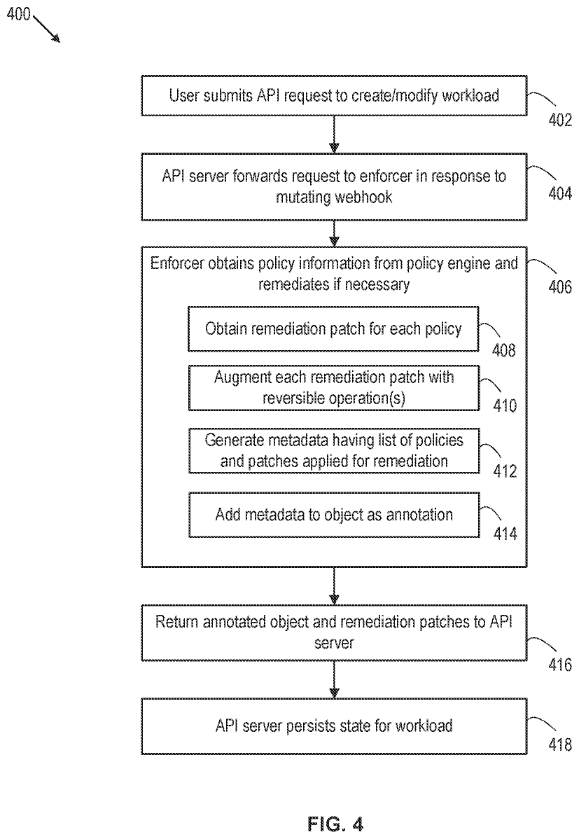

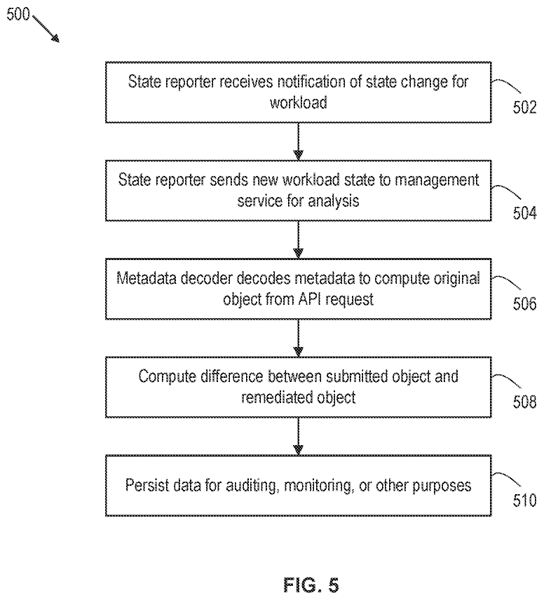

FIG. 3 is a block diagram depicting components of the container orchestrator, the management agent, and the management service according to embodiments. Container orchestrator 52 includes API server 302, mutating webhooks 304, and persistent storage 306 (e.g., a database). Management agent 116 includes enforcer 308, policy engine 310, and state reporter 312. Management service 120 includes metadata decoder 314, difference compute (diff compute 316), and persistent storage 318 (e.g., a database). Functions of the components in FIG. 3 are described below with respect to the flow diagrams in FIGS. 4-5.

FIG. 4 is a flow diagram depicting a method 400 of remediating a user request to modify state of a container workload according to embodiments. Method 400 begins at step 402, where the user submits an API request to modify state of a workload (e.g., a container or containers) to API server 302 (e.g., create or update a workload). At step 404, API server 302 forwards the API request to enforcer 308 in response to mutating webhook 304. Management agent 116 installs a mutating webhook 304 to container orchestrator 52 so that it gets notified of certain state changes being made to workloads.

At step 406, enforcer 308 obtains policy information from policy engine 310 and performs remediation of the API request if necessary. That is, enforcer 308 ensures that the API request and the requested state of the workload complies with one or more defined policies. In embodiments, management agent 116 receives policy information from management service 120 (e.g., configured policies 320). In embodiments, at step 408, enforcer 308 obtains a remediation patch for each policy to be applied to the API request. At step 410, enforcer 308 augments each remediation patch with reversible operation(s). That is, each remediation patch includes one or more operations to be performed on the API request to ensure the state being applied to the workload complies with the defined policies. Enforcer 308 adds operations that can reverse these changes such that, if executed, the original state of the API request can be recovered. At step 412, enforcer 308 generates metadata having a list of policies and patches applied to the API request for remediation. The metadata can be an encoding of this information such that it can be recovered by management service 120 as described below. At step 414, enforcer 308 adds the metadata to the API request.

At step 416, enforcer 308 returns the annotated API request and remediation patches to API server 302. API server 302 then applies the remediation patches to the API request. At step 418, API server 302 persists the state of the workload from the remediated API request in persistent storage 306. In response, container orchestrator 52 will initiate actions to modify the workload to be consistent with the modified state.

FIG. 5 is a flow diagram depicting a method 500 of processing the remediated workload state by management service 120 according to an embodiment. Method 500 begins at step 502, where state reporter 312 receives notification of a state change for a workload from container orchestrator 52. At step 504, state reporter sends the modified workload state to management service 120 for analysis. At step 506, metadata decoder 314 decodes the metadata data from the annotation in the modified state to determine the original state submitted by the user for the API request. The metadata decoder 314 recovers the original state by executing the reverse operations encoded in the metadata to undo the changes made in response to remediation and recover the original state as submitted by the user. At step 508, diff compute 316 determines the difference between the submitted workload state and the remediated workload state. At step 510, management service 120 persists the data in persistent storage 318. A user can access the data for purposes of auditing, monitoring, or various other purposes. The user is able to view the original submitted state for the workload in the API request, which policies were applied during remediation, and the resulting changes made to the state as a result of the remediation.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of any claims. Accordingly, the described embodiments are to be considered as illustrative and not restrictive, and the scope of the claims is not to be limited to details given herein but may be modified within the scope and equivalents of any claims. In any claims, elements and/or steps do not imply any particular order of operation unless explicitly stated in any claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of any claims herein.

What is claimed is:

1. A method of handling a user request to modify state of a container workload in a data center, the method comprising:
receiving the user request at a container orchestrator executing in the data center, the container orchestrator managing the container workload, the container workload executing on a host in the data center;
notifying, by the container orchestrator, a management agent of the user request, the management agent executing in the data center;
receiving, at the container orchestrator from the management agent, an annotated user request and a remediation patch, the annotated user request including metadata describing policies and patches defined in the remediation patch;
applying, by the container orchestrator, the remediation patch to the annotated user request to generate a remediated user request; and
persisting, by the container orchestrator, a state of the container workload in response to the remediated user request.

2. The method of claim 1, further comprising:
obtaining, by the management agent from a management service, a policy to be applied to the container workload, the management service executing in a cloud in communication with the data center through a gateway, the gateway executing the management agent;
obtaining, by the management agent, the remediation patch corresponding to the policy; and
adding, by the management agent, the metadata to the user request to generate the annotated user request.

3. The method of claim 2, further comprising:
augmenting, by the management agent, the remediation patch with a reversible operation configured to reverse an operation defined in the remediation patch.

4. The method of claim 1, wherein the management agent installs a mutating webhook to the container orchestrator and wherein the container orchestrator notifies the management agent of the user request in response to the mutating webhook.

5. The method of claim 1, further comprising:
receiving, at the management agent, a notification of the state of the container workload in response to the persisting by the container orchestrator; and
sending, by the management agent to a management service, the state of the container workload, the management service executing in a cloud in communication with the data center through a gateway, the gateway executing the management agent.

6. The method of claim 5, further comprising:
decoding, by the management service, the metadata from the remediated user request to compute an original object in the user request;
computing, by the management service, a difference between the original object and a remediated object in the remediated user request; and
persisting the difference in persistent storage of the cloud.

7. The method of claim 6, further comprising:
providing, to a user from the management service, the difference between the original object and the remediated object.

8. A non-transitory computer readable medium comprising instructions to be executed in a computing device to cause the computing device to carry out a method of a method of handling a user request to modify state of a container workload in a data center, the method comprising:
receiving the user request at a container orchestrator executing in the data center, the container orchestrator managing the container workload, the container workload executing on a host in the data center;
notifying, by the container orchestrator, a management agent of the user request, the management agent executing in the data center;
receiving, at the container orchestrator from the management agent, an annotated user request and a remediation patch, the annotated user request including metadata describing policies and patches defined in the remediation patch;
applying, by the container orchestrator, the remediation patch to the annotated user request to generate a remediated user request; and
persisting, by the container orchestrator, a state of the container workload in response to the remediated user request.

9. The non-transitory computer readable medium of claim 8, further comprising:
obtaining, by the management agent from a management service, a policy to be applied to the container workload, the management service executing in a cloud in communication with the data center through a gateway, the gateway executing the management agent;
obtaining, by the management agent, the remediation patch corresponding to the policy; and
adding, by the management agent, the metadata to the user request to generate the annotated user request.

10. The non-transitory computer readable medium of claim 9, further comprising:
augmenting, by the management agent, the remediation patch with a reversible operation configured to reverse an operation defined in the remediation patch.

11. The non-transitory computer readable medium of claim 8, wherein the management agent installs a mutating webhook to the container orchestrator and wherein the container orchestrator notifies the management agent of the user request in response to the mutating webhook.

12. The non-transitory computer readable medium of claim 8, further comprising:
receiving, at the management agent, a notification of the state of the container workload in response to the persisting by the container orchestrator; and
sending, by the management agent to a management service, the state of the container workload, the management service executing in a cloud in communication with the data center through a gateway, the gateway executing the management agent.

13. The non-transitory computer readable medium of claim 12, further comprising:
decoding, by the management service, the metadata from the remediated user request to compute an original object in the user request;
computing, by the management service, a difference between the original object and a remediated object in the remediated user request; and
persisting the difference in persistent storage of the cloud.

14. The non-transitory computer readable medium of claim 13, further comprising:
providing, to a user from the management service, the difference between the original object and the remediated object.

15. A computing system having a cloud in communication with a data center, the computing system comprising:
a container workload executing in a host of the data center;
a gateway executing in the data center in communication with the cloud, the gateway configured to execute a management agent; and
a container orchestrator executing in the data center configured to manage the container workload, the container orchestrator configured to:
receive a user request;
notify the management agent of the user request;
receive, from the management agent, an annotated user request and a remediation patch, the annotated user request including metadata describing policies and patches defined in the remediation patch;
apply the remediation patch to the annotated user request to generate a remediated user request; and
persisting a state of the container workload in response to the remediated user request.

16. The computing system of claim 15, wherein the management agent is configured to:
obtain, from a management service executing in the cloud, a policy to be applied to the container workload;
obtain the remediation patch corresponding to the policy; and
add the metadata to the user request to generate the annotated user request.

17. The computing system of claim 16, wherein the management agent is configured to:
augment the remediation patch with a reversible operation configured to reverse an operation defined in the remediation patch.

18. The computing system of claim 15, wherein the management agent installs a mutating webhook to the container orchestrator and wherein the container orchestrator notifies the management agent of the user request in response to the mutating webhook.

19. The computing system of claim 15, wherein the management agent is configured to:
receive a notification of the state of the container workload in response to the persisting by the container orchestrator; and
send, to a management service, the state of the container workload, the management service executing in a cloud in communication with the data center through a gateway, the gateway executing the management agent.

20. The computing system of claim 19, wherein the management service is configured to:
decode the metadata from the remediated user request to compute an original object in the user request;
compute a difference between the original object and a remediated object in the remediated user request; and
persisting the difference in persistent storage of the cloud.
